(19) United States
(12) Patent Application Publication
(10) Pub. No.: US 2004/0142721 A1
(43) Pub. Date: Jul. 22, 2004

(54) Mobile terminal and metal cover-locking apparatus thereof

(75) Inventor: Jong-Woo Kim, Suwon-shi (KR)

Correspondence Address: Paul J. Farrell, Esq., DILWORTH & BARRESE, LLP, 333 Earle Ovington Blvd., Uniondale, NY, 11553, US

(73) Assignee: Samsung Electronics Co. Ltd, Gyeonggi-do (KR)

(21) Appl. No.: 10/754,749

(22) Filed: Jan. 8, 2004

(30) Foreign Application Priority Data
Jan. 8, 2003 (KR) 2003-1098

(51) Int. Cl. H04M 1/00

(52) U.S. Cl. 455/550.1; 455/575.3

(57) ABSTRACT

Disclosed are a mobile terminal and a metal cover-locking device thereof. The metal cover-locking device for locking a first metal cover onto a main housing of a mobile terminal, in which the mobile terminal includes the main housing and a folder rotatably connected to the main housing by a hinge, and a metal cover includes the first metal cover surrounding the main housing and a second metal cover surrounding the folder, includes a reception area recessed at a designated position of the first metal cover; a locking area recessed in the main housing so as to receive the reception area; a movable locker being mounted on the reception area and the locking area, receiving elasticity from a spring so as to become distant from the reception area, and locking or unlocking the first metal cover onto and from the main housing by a pushing and rotating manipulation by a user; and at least one opening respectively formed in the reception area and the locking area so as to vertically move and rotate the movable locker.

### PRIORITY

This application claims priority to an application entitled “MOBILE TERMINAL AND METAL COVER-LOCKING APPARATUS THEREOF”, filed in the Korean Industrial Property Office on Jan. 8, 2003 and assigned Serial No. 2003-01098, the contents of which are hereby incorporated by reference.

### BACKGROUND OF THE INVENTION

1. Field of the Invention

The present invention relates to a mobile terminal, and more particularly to a device for locking and unlocking a metal cover onto and from a main housing of a mobile terminal so as to protect the main housing and diversify the color of the main housing.

2. Description of the Related Art

Usually, mobile terminals refer to miniaturized and lightweight portable electronic devices including a PDA (Personal Digital Assistant), an HHP (Hand Held Phone), a cellular phone, a palm PC, a small-sized notebook computer, etc. The mobile terminal is a device for communicating with a counterpart via wireless communication using a base station. Such a mobile terminal essentially comprises a data input/output unit, a transmission and reception unit, an antenna unit, and a battery pack consisting a plurality of battery cells for supplying power. The battery pack is typically detachably attached to a main housing so that the battery pack can be replaced or recharged by a charger.

Such mobile terminals are small enough to be worn on designated regions of a human body, thereby being more easily exposed to impact as compared to other electronic devices. That is, in case where the mobile terminal falls to the ground, a main housing of the mobile terminal, circuitry installed within the main housing, an antenna unit, etc., can be damaged. Such damage may cause malfunction of the mobile terminal, since the conventional mobile terminal does not have any protective means. Further, since the use of the same mobile terminal for a long period of time can bore users, there are users who frequently replace their terminal with a new one so as to follow fashionable trends.

Therefore, there is a need for protective means for protecting mobile terminals from impact, and a locking device for replacing the protective means with another one so as to provide interchangeability.

### SUMMARY OF THE INVENTION

Therefore, it is an object of the present invention to provide a mobile terminal comprising a detachable and exchangeable metal cover.

It is another object of the present invention to provide a device for locking a detachable and exchangeable metal cover onto a main housing of a mobile terminal.

In accordance with one aspect of the present invention, the above and other objects can be accomplished by the provision of a mobile terminal with a main housing and a folder rotatably connected to the main housing by a hinge, comprising: a first metal cover surrounding both side surfaces, a lower surface, and an edge of a front surface of the main housing; a second metal cover surrounding both side surfaces, an upper surface, and an edge of a front surface of the folder; and a locking device for attaching and detaching the first metal cover to and from the main housing.

In accordance with another aspect of the present invention, there is provided a device for locking a first metal cover onto a main housing of a mobile terminal, in which the mobile terminal includes the main housing and a folder rotatably connected to the main housing by a hinge, and a metal cover which includes the first metal cover surrounding the main housing and a second metal cover surrounding the folder, comprising: a reception area recessed at a designated position of the first metal cover; a locking area recessed in the main housing so as to receive the reception area; a movable locker being mounted on the reception area and the locking area, receiving elasticity from a spring so as to become distant from the reception area, and locking or unlocking the first metal cover onto and from the main housing by a pushing and rotating manipulation by a user; and at least one opening respectively formed in the reception area and the locking area so as to vertically move and rotate the movable locker.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a mobile terminal in a closed condition of a folder onto a main housing in accordance with a preferred embodiment of the present invention;

FIG. 2 is a perspective view of the mobile terminal in an opened condition of the folder from the main housing in accordance with the preferred embodiment of the present invention;

FIG. 3 is a perspective view of a lower surface of the mobile terminal employing a metal cover-locking device in accordance with the preferred embodiment of the present invention;

FIG. 4 is an exploded perspective view of the mobile terminal employing the cover-locking device in accordance with the preferred embodiment of the present invention;

FIG. 5 is a plan view of the mobile terminal employing the metal cover-locking device in a locked state, in accordance with the preferred embodiment of the present invention;

FIG. 6 is an enlarged plan view of a reception area on a metal cover in accordance with the preferred embodiment of the present invention;

FIG. 7 is an enlarged plan view of a locking area on a lower surface of the main housing in accordance with the preferred embodiment of the present invention;

FIG. 8a is a cross-sectional view taken along the line X-X of FIG. 5 in a locked state; and

FIG. 8b is a cross-sectional view taken along the line X-X of FIG. 5 in an unlocked state.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention unclear.

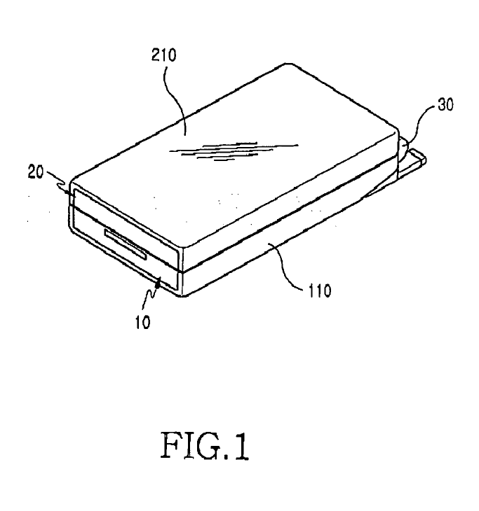

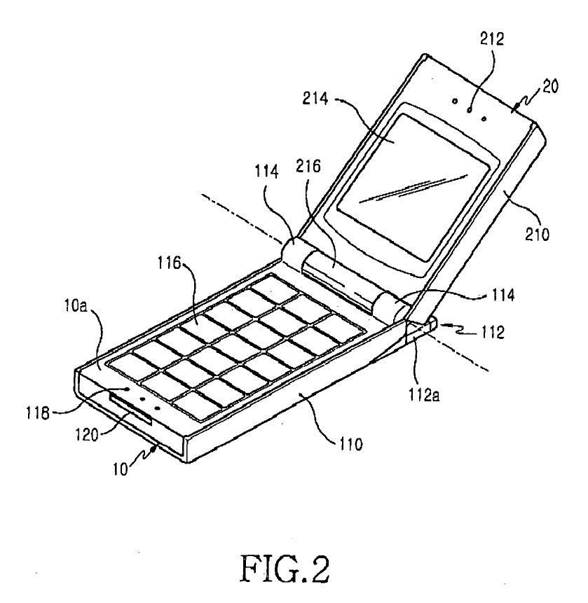

As shown in FIGS. 1 to 3, a mobile terminal employing a locking device 40 of the present invention comprises a main housing 10, a folder 20 rotatably connected to the main housing 10 by a hinge 30, and first and second metal covers 110 and 210 for protecting the main housing 10 and the folder 20. Herein, the first and second metal covers 110 and 210 serve to protect the main housing 10 and the folder 20 from impact, and are often exchanged by other ones. Particularly, when a battery pack is recharged, the first and second metal covers 110 and 210 are separated from the main housing 10 and the folder 20. The first and second metal covers 110 and 210 have various colors, and are made of lightweight aluminum alloy. That is, the first and second metal covers 110 and 210 of the present invention have a protective function and exchangeability. The locking device 40 of the present invention locks and unlocks the first metal cover 110 onto and from the main housing 10. The locking device 40 is attachable and detachable in a vertical direction with respect to first metal cover 110.

The main housing 10 includes a pair of side hinge arms 114, an antenna device 112, a key array 116, a microphone device 118, and an interfacing connector 120. The pair of the side hinge arms 114 are respectively formed on both sides of a top portion of the main housing 10 so that the side hinge arms 114 are opposite each other. The key array 116 consisting of a plurality of keys is arranged on an upper surface 10a of the main housing 10.

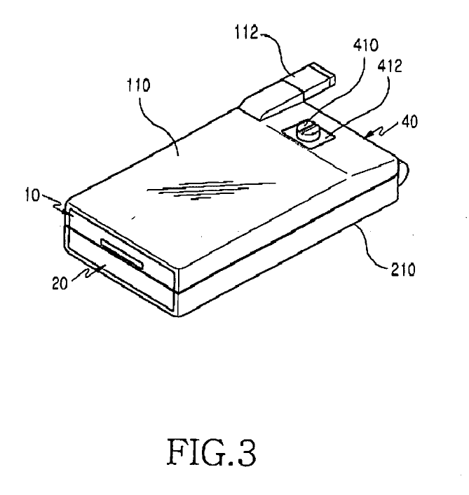

As shown in FIG. 3, the locking device 40 of the present invention includes a movable locker 410 and a support frame 412 for supporting the movable locker 410. The movable locker 410 and the support frame 412 are exposed from the first metal cover 110.

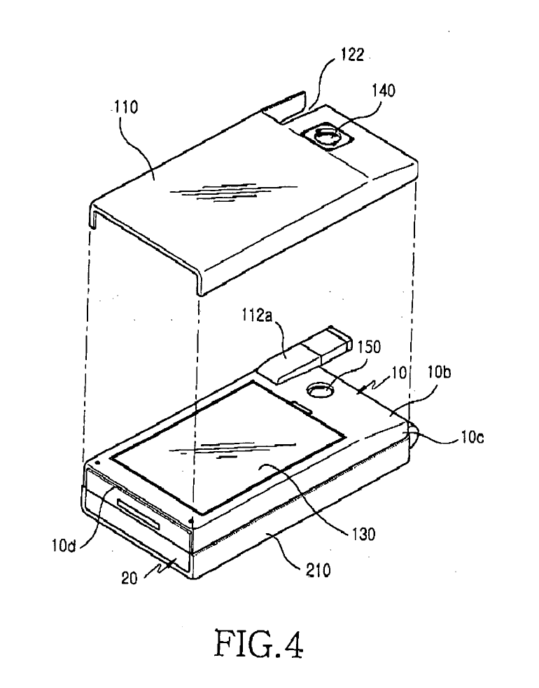

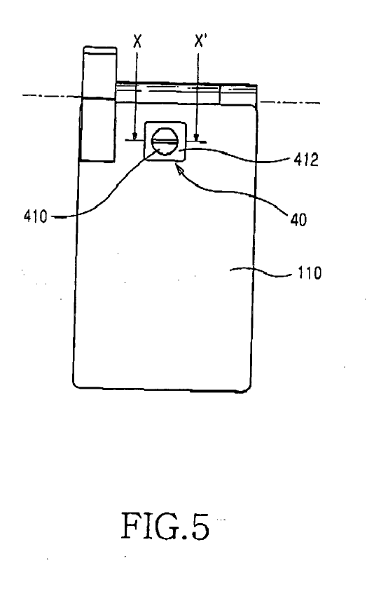

As shown in FIGS. 4 and 5, a lower surface 10b, side surfaces 10c, and an edge 10d of a front surface of the main housing 10 are surrounded by the first metal cover 110. The first metal cover 110 is attached to and detached from the main housing 10 by the locking device in a vertical direction. An upper surface, side surfaces, and an edge of a front surface of the folder 20 are surrounded by the second metal cover 210. The locking device 40 locks the first metal cover 110 closely to the main housing 10. The first metal cover 110 preferably includes an antenna opening 122 and a cylinder-shaped reception area 140. The antenna opening 122 is formed through the metal cover 110 so as to accommodate an antenna housing 112a. Terminals having antennas extending directly from a top edge of the terminal may have antenna opening 122 eliminated. The movable locker 410 and the support frame 412 are attached into the reception area 140. Herein, the reception area 140 is recessed so as to receive the movable locker 410 and the frame 412 for supporting the movable locker 410.

Preferably, the main housing 10 further includes a cylinder-shaped locking area 150 so as to be aligned with the reception area 140. As shown, the first metal cover 110 covers and protects a battery pack 130.

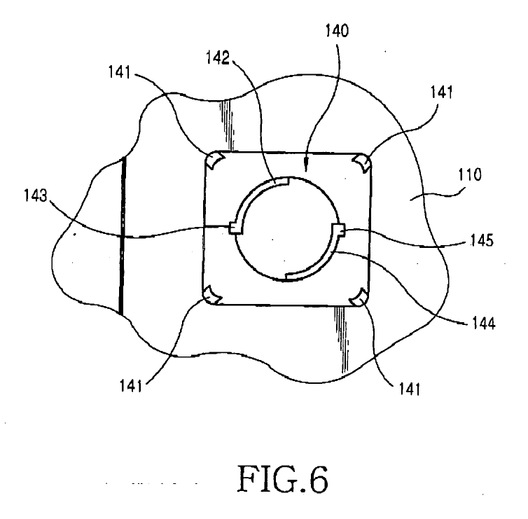

As shown in FIG. 6, locking openings 141 are respectively formed at four corners of the cylinder-shaped reception area 140 of the first metal cover 110, and first and second movable openings 142 and 144 having a designated shape are formed on the bottom surface of the reception area 140. Hooks (not shown) of the frame 412 are connected to the corresponding locking openings 141 so that the frame 412 is fixed to the reception area 140. The first and second movable openings 142 and 144 are symmetrical to the center of the reception area 140. Preferably, the first and second movable openings 142 and 144 have a designated radius of curvature, and extend in an outer circumferential direction so as to have a designated length. Herein, first and second unlocking openings 143 and 145 are respectively formed at ends of the first and second movable openings 142 and 144. The first and second unlocking openings 143 and 145 have a designated radius of curvature larger than that of the first and second movable openings 142 and 144, and extend in an outer circumferential direction so as to have a designated length.

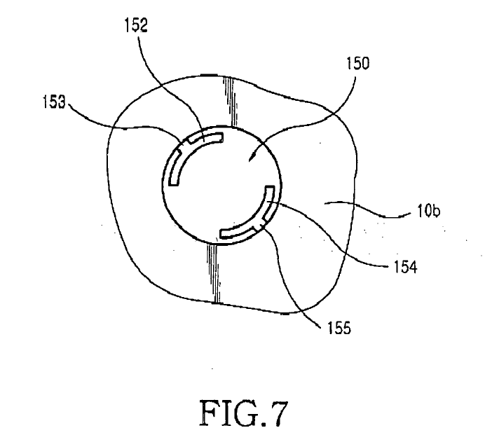

As shown in FIG. 7, third and fourth movable openings 152 and 154 having a designated shape are formed on the bottom surface of the locking area 150 formed at a designated position of the lower surface 10b of the main housing 10 so as to correspond to the reception area 140. The third and fourth movable openings 152 and 154 are symmetrical to the center of the locking area 150. Further, third and fourth unlocking openings 153 and 155 are respectively formed at the center of each of the third and fourth movable openings 152 and 154. The third and fourth movable openings 152 and 154 extend in an outer circumferential direction, and have a designated length. The third and fourth unlocking openings 153 and 155 serve to release engagement protrusions of free ends of the movable locker 410 therefrom. Herein, when the reception area 140 is connected to the locking area 150, the first and second movable openings 142 and 144 are coaxially disposed on the third and fourth movable openings 152 and 154, but the first and second unlocking openings 143 and 145 are non-coaxially disposed on the third and fourth unlocking openings 153 and 155.

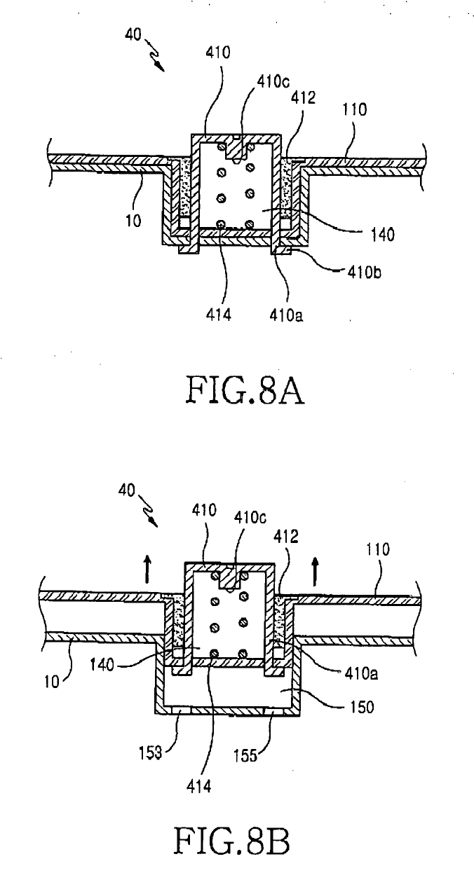

With reference to FIGS. 8a and 8b, a locking and unlocking operation of the above-described locking device 40 of the present invention is described, as follows. As shown in FIG. 8a, the movable locker 410 is installed so as to be vertically movable and rotatable within a designated angle, i.e., the lengths of the first, second, third, and fourth movable openings 142, 144, 152, and 154. The movable locker 410 includes two extended free ends 410a, two engagement protrusions 410b formed in an outer circumferential direction and extended from the free ends 410a, and a spring-fixing protrusion 410c downwardly extended from the center of the movable locker 410.

The movable locker 410 and the frame 412 are mounted on the reception area 140 of the first metal cover 110. Herein, the free ends 410a of the movable locker 410 pass through the first and second movable openings 142 and 144, and then pass through the third and fourth movable openings 152 and 154 of the locking area 150. Then, a locked state of the movable locker 410 onto the main housing 10 is maintained by the engagement protrusions 410b.

In order to unlock the movable locker 410 from the main housing 10 of the mobile terminal, a user pushes the upper surface of the movable locker 410 by a designated force, and then rotates the movable locker 410 at a designated angle (less than approximately 90°). When the engagement protrusions 410b of the movable locker 410 are disposed on the third and fourth unlocking openings 153 and 155, the user ceases the force applied to the upper surface of the movable locker 410. Then, the movable locker 410 is released from the third and fourth unlocking openings 153 and 155, thereby separating the first metal cover 110 from the main housing 10. On the other hand, in order to lock the movable locker 410 onto the main housing 10 of the mobile terminal, the user manipulates the movable locker 410 opposite to the above-described sequence. A known spring 414 is interposed between the movable locker 410 and the reception area 140, thereby providing elastic force so that the movable locker 410 and the reception area 140 are biased away from each other. Herein, one end of the spring 414 is attached to the ceiling surface of the movable locker 410, and the other end of the spring 414 is attached to the bottom surface of the reception area 140.

When the above-described locking device 40 releases the terminal housing from the first metal cover 110, the first metal cover 10 may be variously exchanged with other covers according to a user's taste. That is, when the engagement protrusions 410b of the movable locker 410 are separated from the first and second unlocking openings 143 and 145, the movable locker 410 is separated from the first metal cover 110.

Therefore, users may prepare plural first metal covers 110 having various colors, and then exchange the first metal covers 110 with each other regardless of time and place. Preferably, a slot is formed in the upper surface of the movable locker 410 so that the movable locker 410 is rotated by means of a tool such as a screwdriver or coin inserted into the slot.

As apparent from the above description, the present invention provides a mobile terminal comprising a detachable and exchangeable cover, and a device for locking a detachable and exchangeable cover onto a main housing of a mobile terminal, thereby protecting the mobile terminal from impact, and allowing the cover to be replaced with other covers having various colors.

Although only a few embodiments of the present invention have been described in detail, those skilled in the art will appreciate that various modifications, additions, and substitutions to the specific elements are possible, without departing from the scope and spirit of the invention as disclosed in the accompanying claims. While the detachable and exchangeable covers are described herein as being metal covers, it is clear that covers of any suitable material can be used to provide protection for the terminal and aesthetic interchangeability.

What is claimed is:

1. A mobile terminal with a main housing and a folder rotatably connected to the main housing by a hinge, comprising:
a first cover surrounding both side surfaces, a lower surface, and an edge of a front surface of the main housing;
a second cover surrounding both side surfaces, an upper surface, and an edge of a front surface of the folder; and
a locking device for attaching and detaching the first cover to and from the main housing.

2. The mobile terminal as set forth in claim 1,
wherein the locking device is attached to and detached from a designated position on the lower surface of the main housing in a vertical direction.

3. The mobile terminal as set forth in claim 1,
wherein the first metal cover includes an antenna opening for accommodating an antenna device.

4. The mobile terminal as set forth in claim 1,
wherein the first and second covers are constructed of metal.

5. A metal cover-locking device for locking a first metal cover onto a main housing of a mobile terminal, in which the mobile terminal includes the main housing and a folder rotatably connected to the main housing by a hinge, and a metal cover includes the first metal cover surrounding the main housing and a second metal cover surrounding the folder, comprising:
a reception area recessed at a designated position of the first metal cover;
a locking area recessed in the main housing so as to receive the reception area;
a movable locker being mounted on the reception area and the locking area, being biased by a spring in a direction away from the reception area, and locking or unlocking the first metal cover onto and from the main housing by a pushing and rotating manipulation by a user; and
at least one opening respectively formed in the reception area and the locking area so as to allow the moveable locker to vertically move and rotate.

6. The metal cover-locking device as set forth in claim 5,
wherein a frame for supporting the movable locker is installed on the reception area.

7. The metal cover-locking device as set forth in claim 5,
wherein the movable locker includes:
two free ends downwardly extended from the movable locker; and
engagement protrusions extended from the free ends in an outer circumferential direction.

8. The metal cover-locking device as set forth in claim 5,
wherein one end of the spring is attached to a ceiling surface of the movable locker, and the other end of the spring is attached to a bottom surface of the reception area.

9. The metal cover-locking device as set forth in claim 5, further comprising:
first and second movable openings formed in a bottom surface of the reception area;
first and second unlocking openings formed at an end of each of the first and second movable openings;
third and fourth movable openings formed in a bottom surface of the locking area; and
third and fourth unlocking openings formed at a center of each of the third and fourth movable openings.

10. The metal cover-locking device as set forth in claim 9,
wherein the first, second, third, and fourth movable openings extend in an outer circumferential direction so as to have a designated length, and wherein the first and second movable openings are coaxially disposed on the third and fourth movable openings, and the first and second unlocking openings are non-coaxially disposed on the third and fourth unlocking openings.

11. The metal cover-locking device as set forth in claim 5,
wherein the reception area and the locking area are cylinder-shaped.

12. A mobile terminal with a main housing and a folder rotably connected to the main housing by a hinge, comprising a first metal cover detachably surrounding both side surfaces, a lower surface, and an edge of a front surface of the main housing: and
a locking device for attaching and detaching the first metal cover to and from the main housing.

13. The mobile terminal as set forth in claim 12, further comprising:
a second metal cover surrounding both side surfaces, an upper surface, and an edge of a front surface of the folder.
